(19) United States
(12) Patent Application Publication
(10) Pub. No.: US 2007/0087713 A1
(43) Pub. Date: Apr. 19, 2007

(54) Method and system for balancing load across carrier seams in a multi-band system

(76) Inventors: Ronald Scott Core, Cave Creek, AZ (US); Vivek G. Naik, Deerfield, IL (US); Christopher R. Schmidt, Pinole, CA (US)

Correspondence Address: MOTOROLA, INC., LAW DEPARTMENT, 1303 E. ALGONQUIN ROAD, SCHAUMBURG, IL, 60196, US

(21) Appl. No.: 11/250,293

(22) Filed: Oct. 13, 2005

(51) Int. Cl. H04B 1/18

(52) U.S. Cl. 455/188.1; 455/180.1

(57) ABSTRACT

A method and system for balancing load across a carrier seam (108) is disclosed. The method includes generating a candidate carrier list (210) at a communication device (106). The candidate carrier list comprises carriers from at least two bands in a region of the multi-band cellular network. The method further includes selecting a band through a carrier selection from the candidate carrier list. A carrier is selected from carriers in the band. The communication device then connects to the carrier.

### RELATED APPLICATIONS

Related subject matter is disclosed in U.S. patent application entitled “METHOD AND SYSTEM FOR BALANCING LOAD IN A MULTI-BAND SYSTEM” having application Ser. No.______ and filed on the same date herewith and assigned to the same assignee.

### BACKGROUND OF THE INVENTION

Nowadays, cellular networks are rapidly changing with increased mobility of communication devices. The communication devices themselves are multi-featured and assist users in daily activities. Further, communication devices can now operate in multi-band cellular networks. Examples of bands in a multi-band cellular network include the 800 MHz Code Division Multiple Access (CDMA) band in the United States, the 800 MHz CDMA band in Japan, the 2.1 GHz CDMA band, and the 1900 MHz Personal Communications Service (PCS) band. Network load is increased due to the increased number of communication devices across the plurality of bands in the multi-bands cellular networks. Load balancing is required to uniformly distribute the network load across all the bands in the plurality of regions in the multi-band cellular networks.

In multi-band cellular networks, communication devices acquire carriers in different frequency bands. A carrier in a particular band corresponds to a particular frequency on which a communication device works. While a user of the communication device travels across regions, the communication device may cross a carrier seam. This means that the communication device may lose contact with one multi-band cellular network and have to connect to a second multi-band cellular network. This may happen when, for example, the user travels to a different city, or from a rural area to an urban area. By default, current communication devices connect the same band in the second multi-band cellular network. For example, if a communication device is connected to the 2.1 GHz CDMA band in the first multi-band cellular network, it connects to the same band in the second multi-band cellular network. This band can then get overloaded, while other bands in the second multi-band cellular network remain under-utilized.

In a known method for load balancing, in case the band in the second multi-band cellular network to which the communication device connects gets congested, a message is sent to the communication device to try connecting to another band. However, the message is sent only when the band is already overloaded. The overloading can lead to failures in connection of calls and disconnection of active calls. Further, in current multi-band cellular networks, load distribution is achieved only at the infrastructure systems. Therefore, any changes in the methodology for load balancing require a change in the software at all infrastructure systems. Furthermore, load balancing at the infrastructure level can impact large amounts of communication devices causing congestion on the target band.

### BRIEF DESCRIPTION OF THE DRAWINGS

The present invention is illustrated by way of example and not limitation in the accompanying figures, in which like references indicate similar elements, and in which:

FIG. 1 representatively illustrates a block diagram of a multi-band cellular network, in accordance with an exemplary embodiment of the present invention.

FIG. 2 representatively illustrates a block diagram of a communication device, in accordance with another exemplary embodiment of the present invention.

FIG. 3 representatively illustrates a block diagram of a communication device sub-system performing hash operation for selecting a carrier, in accordance with yet another exemplary embodiment of the present invention.

FIG. 4 representatively illustrates a flowchart depicting a method for balancing load across a carrier seam in a multi-band cellular network, in accordance with an exemplary embodiment of the present invention.

FIG. 5 representatively illustrates a flowchart depicting a method for balancing load across a carrier seam in a multi-band cellular network, in accordance with another exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail the particular method and system for balancing load across carrier seams in a multi-band system in accordance with the present invention, it should be observed that the present invention resides primarily in combinations of method steps and apparatus components related to method and system for balancing load in a multi-band system. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

In accordance with an embodiment of the present invention, a communication device capable of operation in a multi-band system is disclosed. The communication device includes a transceiver, a memory, a hashing module and a processor. The transceiver is used for detecting when the communication device moves across a carrier seam. The memory stores a candidate carrier list. The candidate carrier list includes carriers from at least two bands in the multi-band system. The hashing module performs at least one hash operation on a communication device specific property over the candidate carrier list stored in the memory. The processor then selects a carrier from the candidate carrier list based on the output of the at least one hash operation.

In accordance with another embodiment of the present invention, a method for balancing load across carrier seams in a multi-band system is disclosed. To balance load, a candidate carrier list is generated at a communication device. The candidate carrier list includes carriers from at least two bands in the multi-band system. After the candidate carrier list is generated, a band is selected through a carrier selection from the candidate carrier list. Further, the communication device is connected to a carrier from the band.

In accordance with yet another embodiment of the present invention, a method for balancing load across carrier seams in a multi-band system is disclosed. The method includes generating a candidate carrier list at a communication device wherein the candidate carrier list comprises carriers from at least two bands in the multi-band system. A plurality of hash operations are performed on a communication device specific property. A band is selected through a carrier selection from the candidate carrier list based on the plurality of hash operations. The communication device is then connected to a carrier from the selected band.

FIG. 1 representatively illustrates a block diagram of an environment in which various embodiments of the present invention can be practiced. FIG. 1 shows a first multi-band system 102 and a second multi-band system 104. The multi-band system 102 offers telecommunications services in a first region. Similarly, the multi-band system 104 offers telecommunications services in a second region. For example, the multi-band system 102 can offer services in a rural region, while the multi-band system 104 can offer services in an urban region. A communication device 106 can connect to and communicate through the bands in the multi-band systems 102 and 104 across the two regions. The communication device 106 can travel from the rural area to the urban area and connect to a band in the multi-band system 104. The point at which the communication device 106 disconnects from the multi-band system 102 and connects to the multi-band system 104 is referred to as a carrier seam 108. Therefore, the carrier seam 108 provides an interface between the two regions. The multi-band system 104 comprises two bands, namely band 1 and band 2. Each band includes a plurality of carriers. A carrier in a band corresponds to a frequency on which a communication device receives and transmits data. As the concentration of communication devices is likely to be higher in urban areas, the multi-band system 104 offers more channels as compared to the multi-band system 102. As shown in FIG. 1, the multi-band system 104 has two bands with seven carriers, namely 1-1, 1-2, 1-3, 1-4, 2-1, 2-2 and 2-3. Though various embodiments of the present invention are explained with respect to two multi-band systems, it should be appreciated that these embodiments can be practiced when only one of the communication networks is a multi-band system, and the communication device 106 travels into this multi-band system.

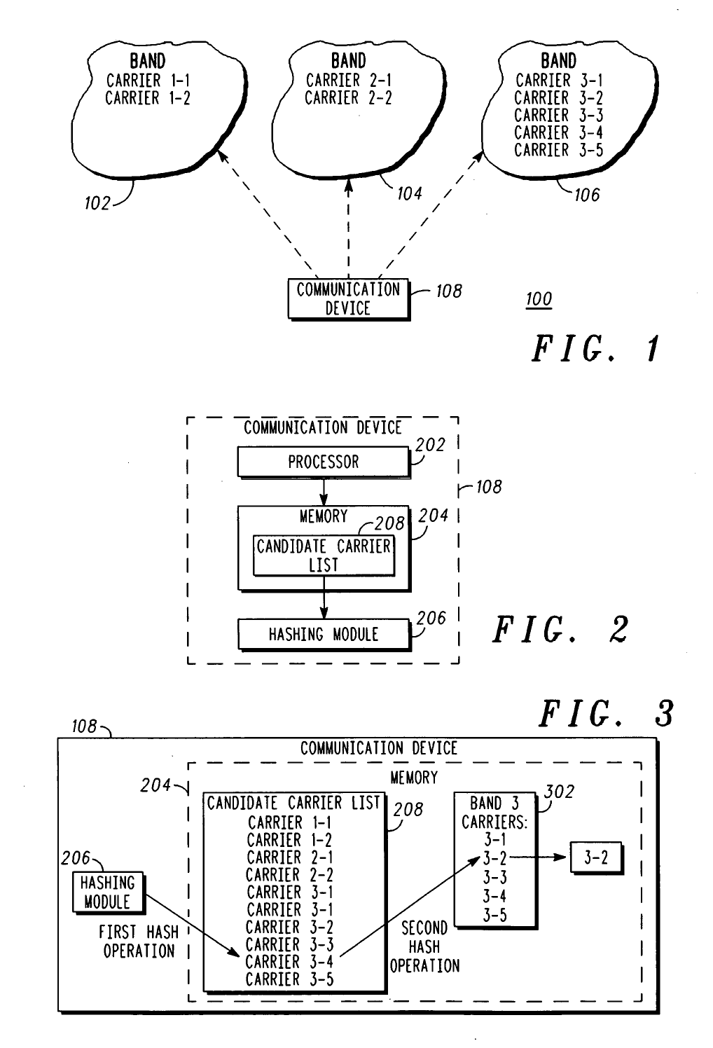

FIG. 2 representatively illustrates a block diagram of a communication device 106, in accordance with an exemplary embodiment of the present invention. The communication device 106 can travel across the carrier seam 108 and connect to the multi-band cellular network 104. The communication device 106 includes a transceiver 202, a processor 204, a memory 206 and a hashing module 208. The transceiver 202 detects when the communication device 106 moves across the carrier seam 108 and needs to connect to the multi-band system 104. The communication device 106 can request the multi-band system 104 to provide a list of carriers that are available in each band. On obtaining lists of carriers from each of the bands of the multi-band system 104, the communication device 106 creates a candidate carrier list 210. The candidate carrier list 210 comprises all carriers available in the bands in the multi-band system 104 to which the communication device 106 can connect. Therefore, the candidate carrier list 210 generated by the communication device 106 includes the carriers available with the two bands in the multi-band system 104. The memory 206 stores the candidate carrier list 210. The hashing module 208 can perform a plurality of hash operations on a communication device specific property. Based on the plurality of hash operations, a carrier is selected from the candidate carrier list 210. Examples of the communication device specific property include, but are not limited to, an Electronic Serial Number (ESN), an International Mobile Subscriber Identity (IMSI), an International Mobile Equipment Identity (IMEI) number and a Mobile Identification Number (MIN).

The processor 204 directs the communication device 106 to connect to the carrier selected based on the result of the hashing module 208. The processor 204 can be a microprocessor or an ASIC (Application Specific Integrated Circuit) embedded in the communication device 106.

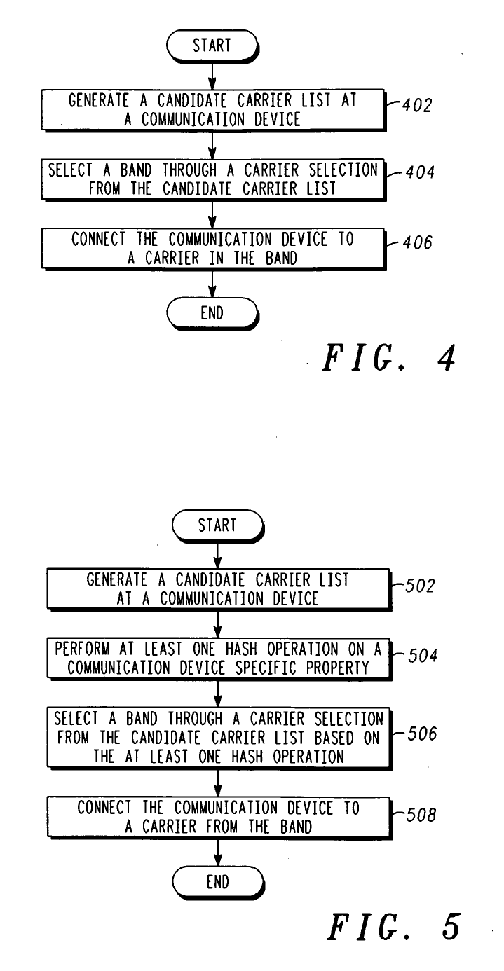

FIG. 3 representatively illustrates a block diagram showing the selection of a final carrier 2-1, in accordance with an exemplary embodiment of the present invention. The communication device 106 stores the candidate carrier list 210 in the memory 206. The hashing module 208 performs a first hash operation over the candidate carrier list 210, the result of which is a carrier 2-2 in the band 2. An exemplary hash operation is described in a CDMA2000 standards documentation titled ‘Upper Layer (Layer 3) Signaling Standard for cdma2OOO Spread Spectrum Systems’, release D, published by the Third Generation Partnership Project 2 (3GPP2), on page 2-621. The hashing module 208 then performs a second hash operation over the carriers list for the band 2 which results in the selection of the final carrier 2-1. The communication device 106 then connects and starts communication through the final carrier 2-1.

FIG. 4 representatively illustrates a flowchart depicting a method for balancing load across a carrier seam, in accordance with an exemplary embodiment of the present invention. The carrier seam provides an interface between a first region and a second region. The second region has a multi-band communication system. Each band in the communication system has at least one carrier. A communication device can connect to at least two bands in the multi-band communication system. At step 402, a candidate carrier list is generated at the communication device. In an embodiment of the invention, the list of carriers that form a part of the candidate carrier list are obtained from the at least two bands of the multi-band communication system. At step 404, a band is selected from the candidate carrier list through a carrier selection. In accordance with an embodiment of the invention, the carrier selection comprises performing a first hash operation on a communication device specific property. Examples of the communication device specific property include, but are not limited to, an Electronic Serial Number (ESN), an International Mobile Subscriber Identity (IMSI), an International Mobile Equipment Identity (IMEI) number and a Mobile Identification Number (MIN). The first hash operation can be an existing carrier selection process described in a CDMA2000 standards documentation titled ‘Upper Layer (Layer 3) Signaling Standard for CDMA2000 Spread Spectrum Systems’, release D, published by the Third Generation Partnership Project 2 (3GPP2), on page 2-621. At step 406, the communication device connects to a carrier selected from the band selected at step 404. In an embodiment of the present invention, the carrier to which the communication device connects is selected by performing a second hash operation on the communication device specific property to select the carrier from the carriers obtained from the band that is selected at step 404. The second hash operation can be similar to the first hash operation. However, the second hash operation selects a carrier from the carriers obtained from the selected band, while the first hash operation selects a band from all the carriers to which the communication device can connect.

FIG. 5 representatively illustrates a flowchart depicting a method for balancing load across a carrier seam, in accordance with another exemplary embodiment of the present invention. The carrier seam provides an interface between a first region and a second region. The second region has a multi-band communication system. Each band in the communication system has at least one carrier. A communication device can connect to at least two bands in the multi-band communication system. At step 502, a candidate carrier list is generated at a communication device. In an embodiment of the invention, the list of carriers that form a part of the candidate carrier list are obtained from the at least two bands of the region in the multi-band system. At step 504, at least one hash operation is performed on a communication device specific property. Examples of the communication device specific property include, but are not limited to, an Electronic Serial Number (ESN), an International Mobile Subscriber Identity (IMSI), an International Mobile Equipment Identity (IMEI) number and a Mobile Identification Number (MIN). The first hash operation can be an existing carrier selection process described in a 3GPP2 document. Upper layer (Layer 3) Signaling Standard for CDMA2000 Spread Spectrum System 3GPPS C.S0005-D Version 1.0 dated February 2004 Section 2.6.7.1 page 2-621. At step 506, a band is selected through a carrier selection from the candidate carrier list based on the results of a first hash operation. At step 508, the communication device connects to a carrier selected from the band selected at step 506. In an embodiment of the invention, the carrier to which the communication device connects is selected using a second hash operation. Both the hash operations can be existing carrier selection processes.

Various embodiments of the present invention provide load balancing across carrier seams in multi-band cellular networks offer many advantages. The communication device specific property is unique for every device. The result of the hash operation of the communication device specific property randomly selects the band, and subsequently the carrier, to which the communication device connects. Since this selection can be from any of the bands of the multi-band communication system, and not just from a default band to which the communication device connects, the load across the carrier seams of the multi-band cellular network is more evenly balanced. Further, various embodiments of the present invention can be implemented at the communication device. Therefore, no changes are required at the infrastructure of the multi-band cellular network. The changes in the communication device are also minimal, since existing carrier selection processes can be used while expanding the list of carriers from which the selection is made.

It will be appreciated that the communication device for balancing load across carrier seams in a multi-band system described herein may be comprised of one or more conventional processors and unique stored program instructions that control the one or more processors to implement, in conjunction with certain non-processor circuits, some, most, or all of the functions of the method and system described herein. The non-processor circuits may include, but are not limited to, a radio receiver, a radio transmitter, signal drivers, clock circuits, power source circuits, and user input devices. As such, these functions may be interpreted as steps of a method to balance loads in a multi-band system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for balancing load through a carrier seam, the carrier seam providing an interface between a first region and a second region, the second region having a multi-band system, wherein each band of the multi-band system comprises at least one carrier, the method comprising:
generating a candidate carrier list at a communication device, the candidate carrier list comprising carriers from at least two bands in the multi-band system;
selecting a band through a carrier selection from the candidate carrier list; and
connecting the communication device to a carrier from the band.

2. The method of claim 1 wherein generating the candidate carrier list comprises obtaining carrier lists from at least two bands in the multi-band system.

3. The method of claim 1 further comprising selecting the band from the multi-band system utilizing the candidate carrier list and a communication device specific property.

4. The method of claim 3, wherein selecting the band comprises performing a first hash operation on the communication device specific property.

5. The method of claim 4, wherein performing the first hash operation comprises executing an existing carrier selection process over the candidate carrier list.

6. The method of claim 1, wherein connecting the communication device to the carrier from the band comprises performing a second hash operation on the communication device specific property.

7. The method of claim 6, wherein performing the second hash operation comprises executing an existing carrier selection process over carriers from the band.

8. The method of claim 3, wherein the communication device specific property is selected from a group comprising an Electronic Serial Number (ESN), an International Mobile Subscriber Identity (IMSI), an International Mobile Equipment Identity (IMEI) number and a Mobile Identification Number (MIN).

9. A method for balancing load through a carrier seam, the carrier seam providing an interface between a first region and a second region, the second region having a multi-band system, wherein each band of the multi-band system comprises at least one carrier, the method comprising:
generating a candidate carrier list at a communication device, the candidate carrier list comprising carriers from at least two bands in the multi-band system;
performing at least one hash operation on a communication device specific property;
selecting a band through a carrier selection from the candidate carrier list based on the at least one hash operation; and
connecting the communication device to a carrier from the band.

10. The method of claim 9 wherein generating the candidate carrier list comprises obtaining carrier lists from the at least two bands in the multi-band system.

11. The method of claim 9, wherein performing the at least one hash operation comprises:
performing a first hash operation on the communication device specific property to select the band; and
performing a second hash operation on the communication device specific property to select the carrier from the band.

12. The method of claim 11, wherein performing the first hash operation comprises executing an existing carrier selection process over the candidate carrier list.

13. The method of claim 11, wherein performing the second hash operation comprises executing an existing carrier selection process over carriers from the band.

14. The method of claim 9, wherein the communication device specific property is selected from a group comprising an Electronic Serial Number (ESN), an International Mobile Subscriber Identity (IMSI), an International Mobile Equipment Identity (IMEI) number and a Mobile Identification Number (MIN).

15. A communication device capable of operation in a multi-band system, wherein each band of the multi-band system comprises at least one carrier, the communication device comprising:
a transceiver for detecting when the communication device crosses a carrier seam to enter the multi-band system;
a memory storing a candidate carrier list, the candidate carrier list comprising carriers from at least two bands in the multi-band system;
a hashing module, the hashing module performing at least one hash operation on a communication device specific property; and
a processor selecting a carrier from the candidate carrier list based on the at least one hash operation.

16. The communication device of claim 15, wherein the communication device specific property is selected from a group comprising an Electronic Serial Number (ESN), an International Mobile Subscriber Identity (IMSI), an International Mobile Equipment Identity (IMEI) number and a Mobile Identification Number (MIN).
